(19) United States
(12) Patent Application Publication
(10) Pub. No.: US 2025/0067573 A1
(43) Pub. Date: Feb. 27, 2025

(54) STRUCTURE INVESTIGATION ASSISTANCE SYSTEM, STRUCTURE INVESTIGATION ASSISTANCE METHOD, AND RECORDING MEDIUM

(71) Applicant: NEC Corporation, Minato-ku, Tokyo (JP)

(72) Inventors: Naoko FUKUSHI, Tokyo (JP); Shintaro CHIKU, Tokyo (JP); Shuhei MIZUGUCHI, Tokyo (JP); Masanori KUKI, Tokyo (JP); Shuei YAMADA, Tokyo (JP); Kosei KOBAYASHI, Tokyo (JP)

(73) Assignee: NEC Corporation, Minato-ku, Tokyo (JP)

(21) Appl. No.: 18/729,555

(22) PCT Filed: Feb. 9, 2022
(86) PCT No.: PCT/JP2022/005012

§ 371 Date: Jul. 17, 2024

(51) Int. Cl. G01C 21/00; G06T 17/00

(52) U.S. Cl. CPC G01C 21/3819; G06T 17/00

(57) ABSTRACT

A structure investigation assistance system comprises: a first storage unit that stores image data of a road captured continuously by a camera; a second storage unit that stores detailed information about a structure around the road in association with position information about the structure on a map, the detailed information on the structure being configured using point cloud data obtained by 3D scanning the structure; a first selection unit that selects, from the first storage unit, image data targeted for an investigation request in a case where a request for an investigation of the structure is received; a second selection unit that selects, from the second storage unit, detailed information about the structure targeted for the investigation request; and an information presentation unit that presents a map indicating a location of the structure, the image data selected, and the detailed information about the structure.

### TECHNICAL FIELD

The present invention relates to a structure investigation assistance system, a structure investigation assistance method, and a recording medium.

### BACKGROUND ART

PTL 1 discloses a road structure management system capable of facilitating management of a road structure. According to this document, disclosed is a vehicle information processing device that detects a road structure from image data, identifies a type of the road structure, and then records image data in which the road structure is captured, and a position and a time at which the image data is captured in association with each other. The same document discloses a second information processing device that maps a road structure detected on map data based on information about the road structure received from the vehicle information processing device and is capable of displaying the map data together with information indicating the road structure.

### CITATION LIST

### Patent Literature

PTL 1: JP 2016-151967 A

### SUMMARY OF INVENTION

### Technical Problem

The road structure management system of PTL 1 discloses a configuration in which detailed information can be obtained by selecting information about a road structure represented on a map, but the road structure management system has a problem that it is difficult to identify a structure to be checked because a plurality of road structures of the same type depending on the type of the road structure is present.

In the road structure management system of PTL 1, since the type of the road structure is identified using the image data captured by the front monitoring camera of the vehicle, in a case where the road structure is not clearly shown in the image data, it is expected that it will be difficult to identify the road structure.

An object of the present invention is to provide a structure investigation assistance system, a structure investigation assistance method, and a recording medium that can contribute to facilitating an investigation of a structure around a road.

### Solution to Problem

According to a first aspect, provided is a structure investigation assistance system including a first storage means for storing image data of a road captured continuously by a camera, a second storage means for storing detailed information about a structure around the road in association with position information about the structure on a map, a first selection means for selecting, from the first storage means, image data targeted for an investigation request in a case where a request for an investigation of the structure is received, a second selection means for selecting, from the second storage means, detailed information about the structure targeted for the investigation request, and an information presentation means for presenting a map indicating a location of the structure, the image data selected by the first selection means, and the detailed information about the structure. The structure investigation assistance system configures detailed information about the structure using point cloud data obtained by 3D scanning the structure.

A control system is provided.

According to a second aspect, provided is a structure investigation assistance method including selecting, from a first storage means, image data targeted for an investigation request, the first storage means receiving a request for an investigation of a structure and storing image data of a road continuously captured by a camera, selecting, from a second storage means, detailed information about a structure targeted for the investigation request, the second storage means storing detailed information in association with position information about the structure on a map, the detailed information being configured point cloud data obtained by 3D scanning the structure, and presenting a map indicating a location of the structure, the image data selected by the first selection means, and the detailed information about the structure.

According to a third aspect, provided is a computer-readable recording medium storing a program for causing a computer to execute the steps of selecting, from a first storage means, image data targeted for an investigation request, the first storage means receiving a request for an investigation of a structure and storing image data of a road continuously captured by a camera, selecting, from a second storage means, detailed information about a structure targeted for the investigation request, the second storage means storing detailed information in association with position information about the structure on a map, the detailed information being configured point cloud data obtained by 3D scanning the structure, and presenting a map indicating a location of the structure, the image data selected by the first selection means, and the detailed information about the structure.

### Advantageous Effects of Invention

According to the present invention, there are provided a structure investigation assistance system, a structure investigation assistance method, and a recording medium that can contribute to facilitating an investigation of a structure around a road.

### BRIEF DESCRIPTION OF DRAWINGS

FIG. 1 is a diagram illustrating a configuration of an example embodiment of the present invention.

FIG. 2 is a diagram for describing an information presentation function of a structure investigation assistance system according to an example embodiment of the present invention.

FIG. 3 is a diagram illustrating a configuration of a structure investigation assistance system according to the first example embodiment of the present invention.

FIG. 4 is a diagram illustrating an example of image data acquired by the structure investigation assistance system according to the first example embodiment of the present invention.

FIG. 5 is a diagram for describing point cloud data acquired by the structure investigation assistance system according to the first example embodiment of the present invention.

FIG. 6 is a diagram illustrating a state in which point cloud data is classified for each object and labeled.

FIG. 7 is a diagram illustrating a state in which an object to which a label “street tree” is given is highlighted.

FIG. 8 is a diagram illustrating a state in which objects to which a label “street tree” is given are hidden.

FIG. 9 is a diagram for describing a difference between point cloud data and image data (visible image).

FIG. 10 is a diagram illustrating an example of a method of grasping a state of a street tree using point cloud data.

FIG. 11 is a flowchart illustrating an operation (processing of image data) of the structure investigation assistance system according to the first example embodiment of the present invention.

FIG. 12 is a flowchart illustrating an operation (processing of point cloud data) of the structure investigation assistance system according to the first example embodiment of the present invention.

FIG. 13 is a sequence diagram illustrating an information presentation operation of the structure investigation assistance system according to the first example embodiment of the present invention.

FIG. 14 is a diagram illustrating an example of an integrated screen presented to the in-vehicle terminal of the structure investigation assistance system according to the first example embodiment of the present invention.

FIG. 15 is a diagram illustrating another example of an integrated display screen presented on the in-vehicle terminal of the structure investigation assistance system according to the first example embodiment of the present invention.

FIG. 16 is a diagram illustrating a configuration of a structure investigation assistance system according to the second example embodiment of the present invention.

FIG. 17 is a diagram illustrating an example of design drawing data held by the structure investigation assistance system according to the second example embodiment of the present invention.

FIG. 18 is a diagram illustrating an example of an integrated screen presented to an in-vehicle terminal of the structure investigation assistance system according to the second example embodiment of the present invention.

FIG. 19 is a diagram illustrating a configuration of a computer constituting the structure investigation assistance system of the present invention.

### EXAMPLE EMBODIMENT

First, an outline of an example embodiment of the present invention will be described with reference to the drawings. The reference numerals in the drawings attached to this outline are attached to respective elements for convenience as an example for assisting understanding, and are not intended to limit the present invention to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with equipment (including a computer) inside or outside the device via a communication interface regardless of wired or wireless. Although there are ports and interfaces at connection points of input and output of each block in the drawing, illustration thereof is omitted.

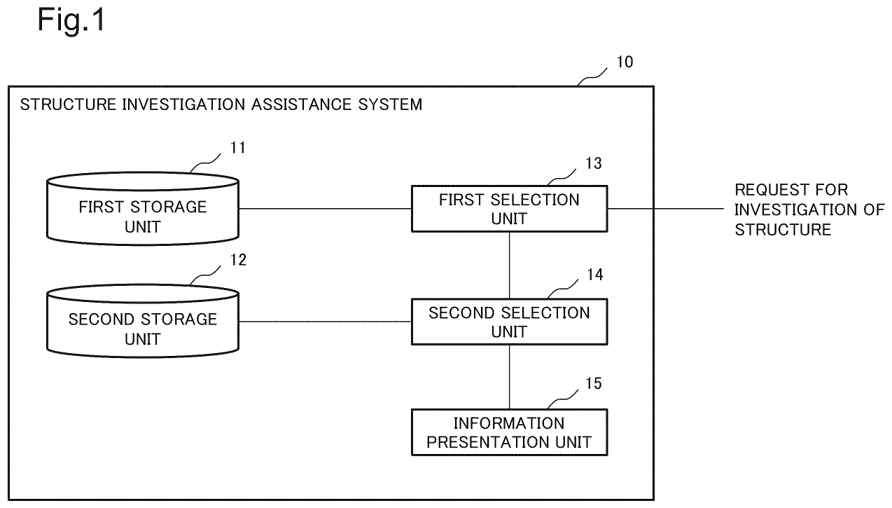

In an example embodiment of the present invention, as illustrated in FIG. 1, the present invention can be implemented by a structure investigation assistance system 10 including a first storage means 11, a second storage means 12, a first selection means 13, a second selection means 14, and an information presentation means 15.

More specifically, the first storage means 11 stores image data of a road continuously captured by a camera. An example of the image data can include data captured by an in-vehicle camera or the like of a vehicle passing through a road.

The second storage means 12 stores, as detailed information about a structure around the road, point cloud data obtained by 3D scanning the structure in association with position information about the structure on a map. In the present specification, the structure includes not only a civil structure and a building structure such as a road, a building, a dam, or an embankment, but also road accessories such as a sign, a guardrail, and a curved mirror.

The first selection means 13 selects, from the first storage means, image data targeted for an investigation request when receiving a request for an investigation of the structure.

The second selection means 14 selects detailed information about the structure targeted for the investigation request from the second storage means.

The information presentation means 15 presents a map indicating the location of the structure, image data selected by the first selection means, and detailed information about the structure.

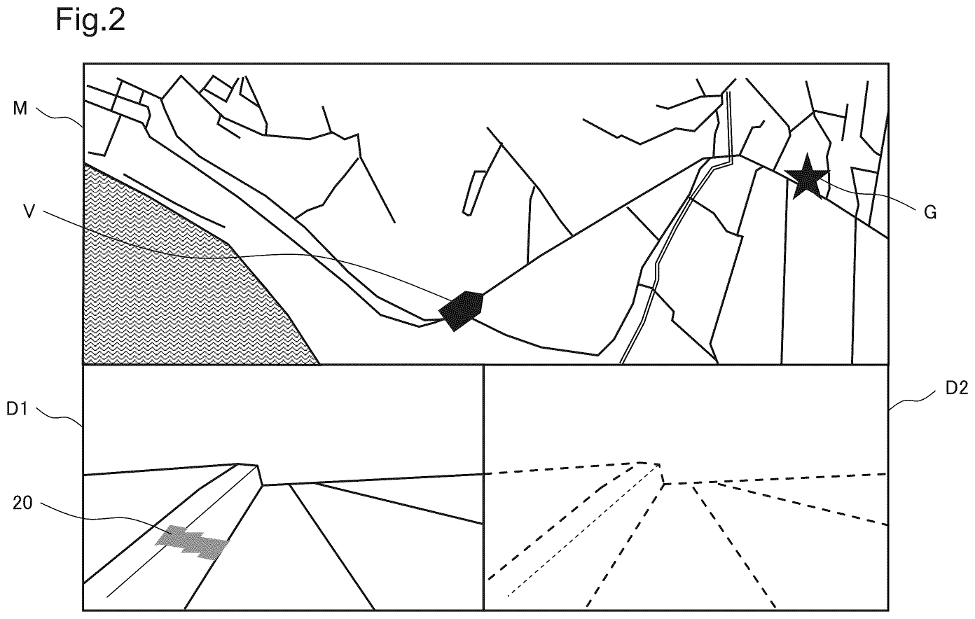

For example, in a case where a request for an investigation of a slope of a road is received as a structure at a destination G from a vehicle V on a map M in the upper part of FIG. 2, the structure investigation assistance system 10 operates as follows.

The structure investigation assistance system 10 selects, from the first storage means 11, image data in a course of that the investigation implementer is heading for the structure from the current location.

The structure investigation assistance system 10 selects, from the second storage means 12, the point cloud data of the slope of the road as the detailed information about the structure targeted for the investigation request.

The structure investigation assistance system 10 presents a map indicating the location of the structure, image data selected by the first selection means 13, and detailed information about the structure.

FIG. 2 is a diagram illustrating an example of a presentation form of a map, image data, and detailed information about a structure by the structure investigation assistance system 10. On the map M in the upper part of FIG. 2, the vehicle V and the destination G where a structure is present are illustrated.

In an area D1 on the lower left of FIG. 2, image data in a course of that the vehicle V is heading for the location G of the structure from the current location is displayed. In the example of FIG. 2, a collapsed portion of the slope indicated by reference numeral 20 appears in the area D1.

The display form of the image data in the area D1 is not limited to the mode illustrated in FIG. 2. For example, it is also possible to adopt a mode in which a plurality of pieces of image data in the course of that the vehicle V is heading for the location G of the structure from the current location is displayed as thumbnail images, and an enlarged image appears when the user selects any thumbnail image. A plurality of pieces of image data in the course of that the vehicle V is heading for the location G of the structure from the current location may be continuously displayed in a switching manner in an animation manner. In these cases, as the image data displayed in the area D1, it is preferable to display image data captured in the course of actually that the vehicle V is heading for the location G of the structure from the current location. In this manner, by matching what is seen in the line-of-sight direction of the investigation implementer with the direction of the camera when the image data is captured, the confirmation of the site is facilitated.

In an area D2 on the lower right of FIG. 2, 3D scanned point cloud data is displayed as detailed information about the structure. For example, in the example of FIG. 2, the point cloud data obtained by 3D scanning the lateral slope of the road is displayed.

While the user boarding the vehicle V or scheduled to board the vehicle V accesses the structure investigation assistance system 10 from an in-vehicle terminal, a personal computer, his/her mobile terminal, or the like, and browses the integrally displayed information illustrated in FIG. 2. The user can identify the structure to be checked by referring to the screen illustrated in FIG. 2, and can easily grasp the degree of damage of the structure by referring to the point cloud data.

Furthermore, in the example of FIG. 2, the point cloud data of the structure when viewed in a direction same as that of the image data is presented. As a result, it is possible to facilitate the field check operation by the user boarding the vehicle V or scheduled to board the vehicle V. In this case, the direction of the point cloud data of the structure may be matched with the direction of the image data represented in the area D1. In this way, it is easy for the investigation implementer to grasp the structure.

### First Example Embodiment

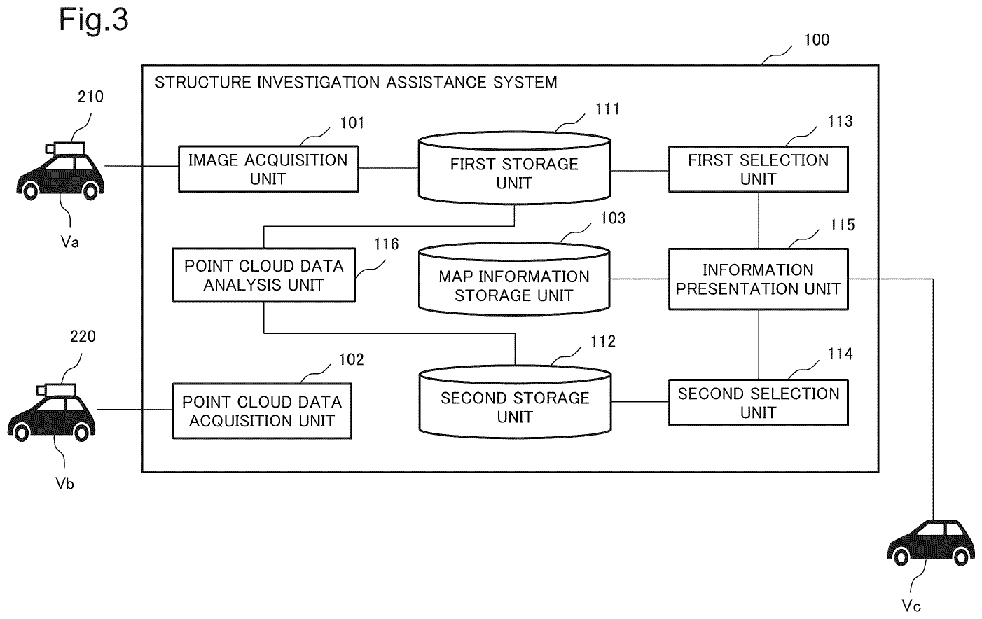

Next, the first example embodiment in which the present invention is applied to inspection work of street trees and signs in an urban area will be described in detail with reference to the drawings. FIG. 3 is a diagram illustrating a configuration of a structure investigation assistance system 100 according to the first example embodiment of the present invention. Referring to FIG. 3, as in FIG. 1, a configuration including a first storage means 111, a first selection means 113, an information presentation means 115, a second storage means 112, and a second selection means 114 is illustrated. Further, the structure investigation assistance system 100 of the present example embodiment includes an image acquisition means 101, a point cloud data analysis means 116, a map information storage means 103, and a point cloud data acquisition means 102.

The image acquisition means 101 acquires image data of a road from a vehicle Va on which a camera 210 is mounted, and stores the image data in the first storage means 111 together with the imaging position and imaging direction information about the image data. The vehicle Va may be a general vehicle in addition to a vehicle of a road administrator or the like of a local government or the like. The imaging position information about the image data may, for example, includes position information measured by a global positioning system (GPS) of the vehicle Va or the camera 210. The imaging direction may be acquired from the vehicle or may be determined from the image.

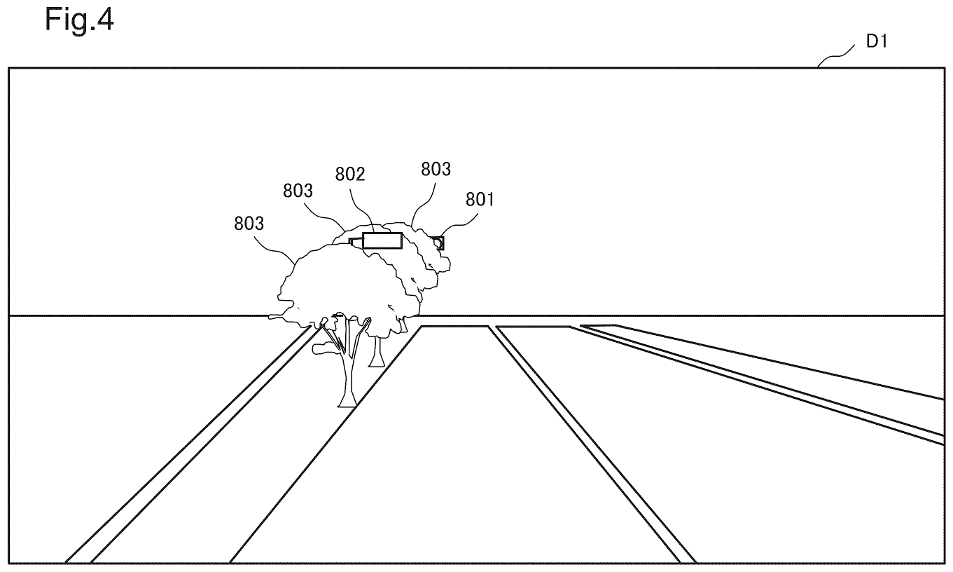

FIG. 4 is a diagram illustrating an example of image data acquired by the structure investigation assistance system 100 of the present example embodiment. Referring to FIG. 4, a street tree 803 in front of each of a traffic signal 801 and a street light 802 is present, and its branch protrude, so that it is difficult to see. In the following description, an example of investigating this street tree and a structure hidden behind the street tree will be described.

The point cloud data acquisition means 102 acquires point cloud data obtained by scanning a structure around the road from a vehicle Vb on which a 3D laser scanner 220 and the like are mounted, and stores the acquired point cloud data in the second storage means 112.

The above-described point cloud data includes, for example, three-dimensional coordinate values (X, Y, Z) and color information (R, G, B). Such point cloud data can be obtained by, for example, emitting line laser light to a structure to be measured in a vertical direction and a horizontal direction, measuring a time for a laser pulse to reciprocate between a measurement point of the object to be measured and a sensor, and obtaining a distance to the measurement point.

Such point cloud data can also be obtained from, for example, an unmanned aerial vehicle (UAV) on which a 3D laser scanner and the like are mounted. The vehicle Va and the vehicle Vb in FIG. 3 may be the same vehicle.

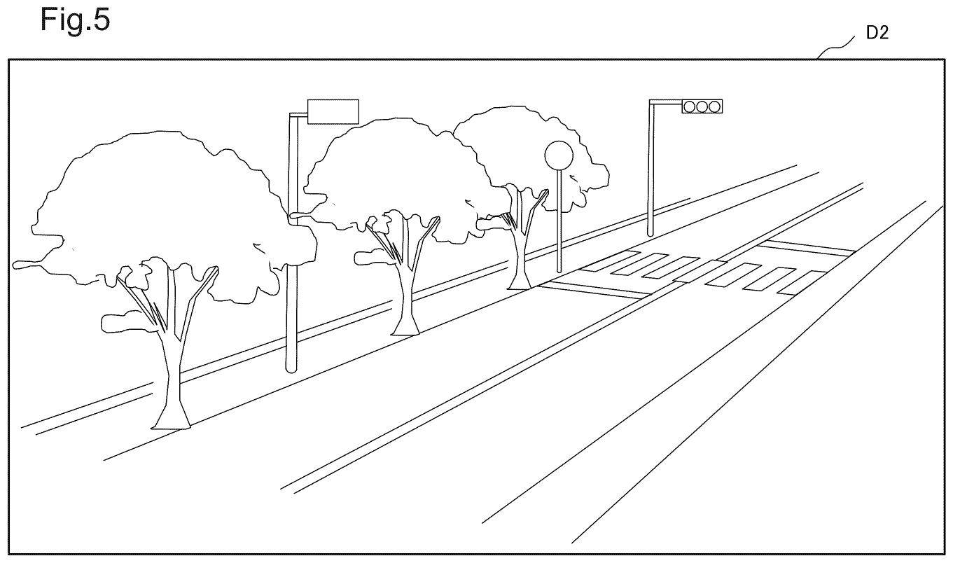

FIG. 5 is a diagram illustrating an example of point cloud data acquired by the structure investigation assistance system of the present example embodiment. Since the point cloud data illustrated in FIG. 5 is a set of three-dimensional coordinate values (X, Y, Z), street trees, street lights, signs, and the like cannot be determined by themselves.

The point cloud data analysis means 116 labels the point cloud data by performing object recognition using artificial intelligence (AI) or the like, and deletes unnecessary data. This process is also referred to as a (3D data) cleaning process. The point cloud data analysis means 116 may refer to the image data stored in the first storage means 111 when performing this cleaning process. In this way, the accuracy of the recognition of the object from the point cloud data can be improved. By using the AI, the point cloud data analysis means 116 can estimate the overall image of the structure hidden by the overlap between the subjects in the image data using the point cloud data. Therefore, the point cloud data analysis means 116 corresponds to an estimation means for estimates the overall image of the structure hidden by the overlap between the subjects in the image data using the point cloud data.

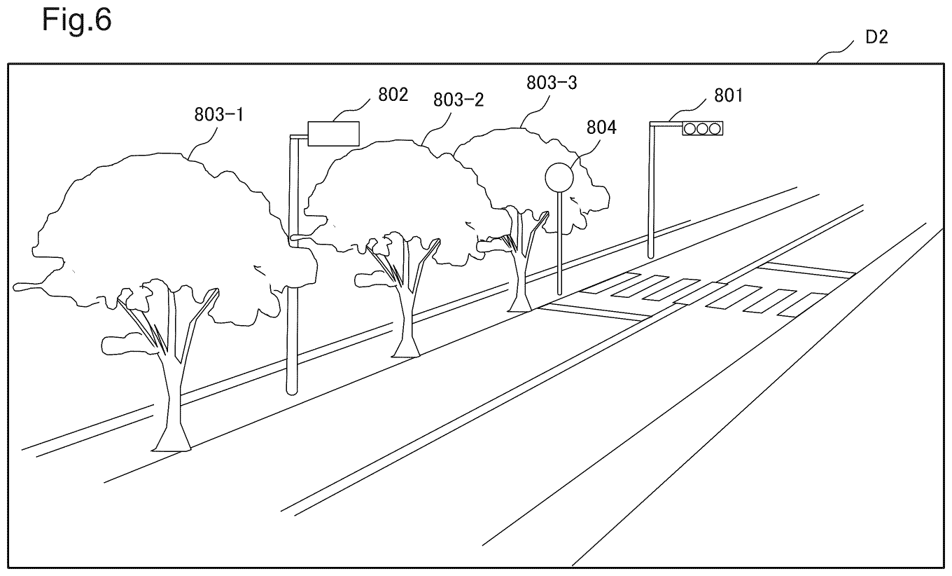

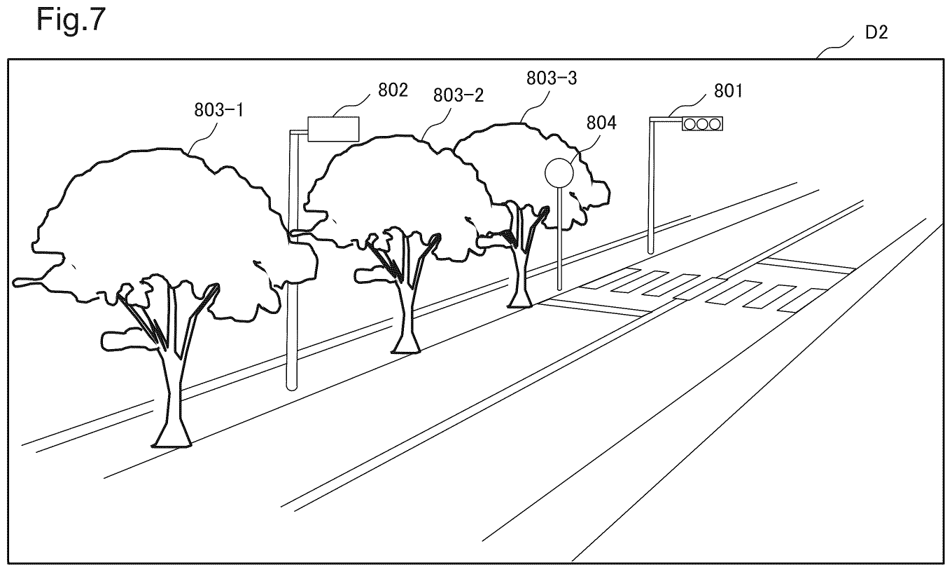

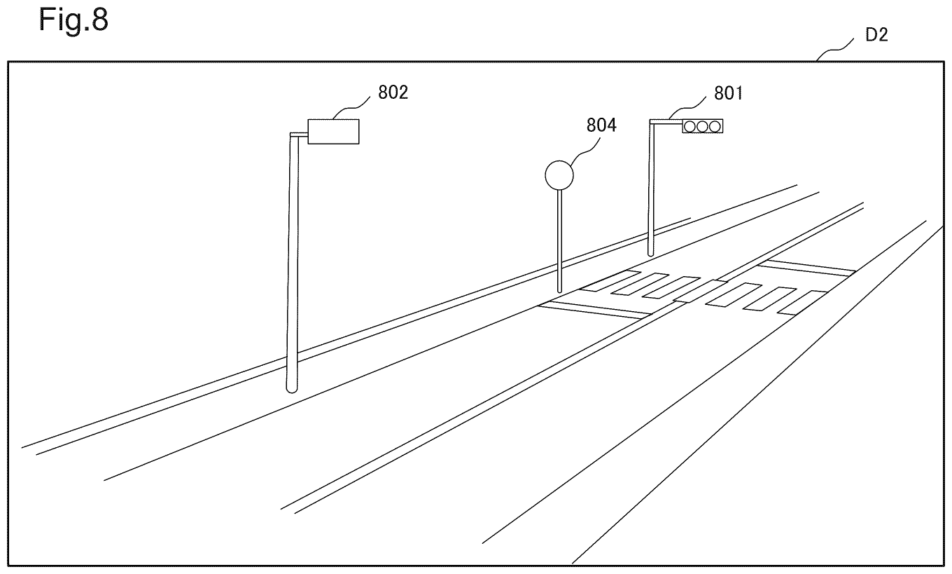

FIG. 6 is a diagram illustrating a state in which the point cloud data of FIG. 5 is classified for each object and labeled. In the example of FIG. 6, three street trees 803-1 to 803-3, a street light 802, a sign 804, and a traffic signal 801 are identified. By performing such labeling, only the street trees 803-1 to 803-3 can be highlighted as illustrated in FIG. 7. By performing such labeling, as illustrated in FIG. 8, it is also possible to remove information about the street trees 803-1 to 803-3 and display only other structures.

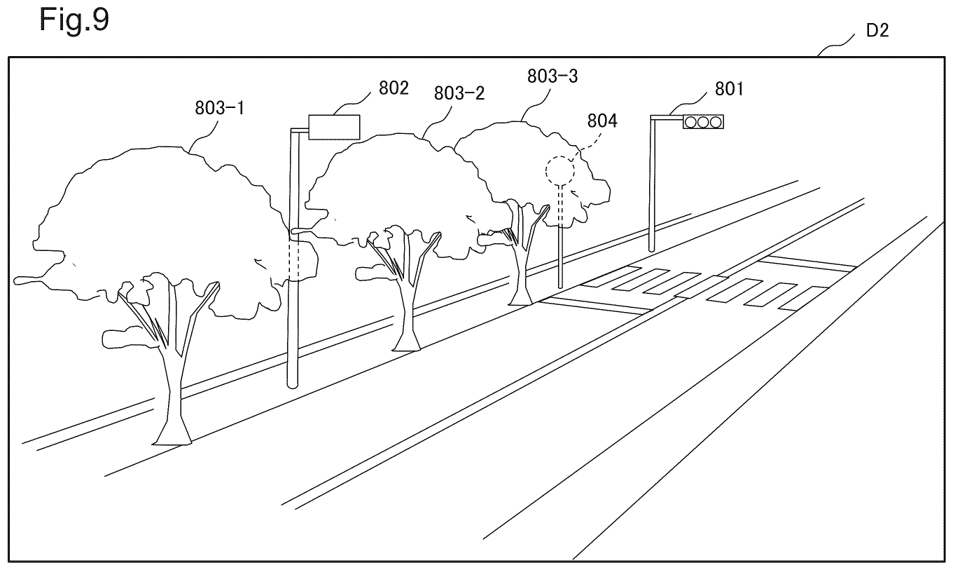

FIG. 9 is a diagram for describing a difference between the point cloud data and the image data (visible image). In the case of the image data (visible image), as indicated by a broken line in FIG. 9, the pillar portion of the street light 802 and the sign 804 are hidden by the street trees 803-1 and 803-3, and it is difficult to grasp them. In the case of the point cloud data after the cleaning process, the data of the portion hidden by the street trees 803-1 and 803-3 is also complemented, so that it is possible to grasp the accurate positional relationship.

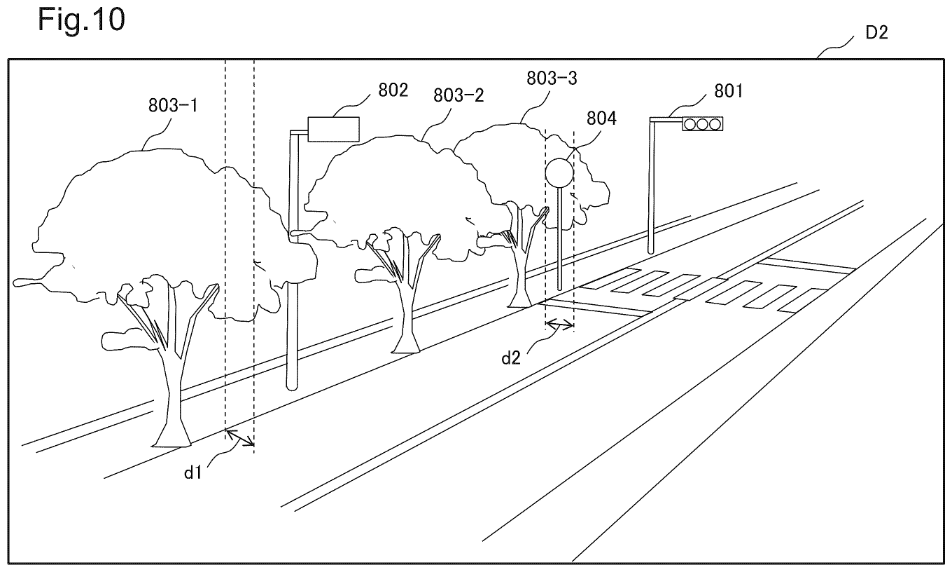

FIG. 10 is a diagram illustrating an example of a method of grasping a state of a street tree using point cloud data. As described above, since the point cloud data is represented by the three-dimensional coordinate values (X, Y, Z), for example, as illustrated in d1 of FIG. 10, it is possible to quantitatively grasp the amount of protrusion of the street tree 803-1 toward the road side. Similarly, as illustrated in d2 of FIG. 10, by comparing the respective coordinates, it is possible to accurately grasp the width of the sign 804 which is hidden by the street tree 803-3.

Referring again to FIG. 3, the first storage means 111 stores the image data with the imaging position and imaging direction information acquired by the image acquisition means 101.

The map information storage means 103 stores map information about an area where a structure to be investigated is present.

The second storage means 112 stores the point cloud data acquired by the point cloud data acquisition means 102.

In a case where a request for an investigation of the structure is received, the first selection means 113 selects, from the first storage means 111, image data in a course of that the investigation implementer is heading for the structure from the current location.

The second selection means 114 selects, from the second storage means 112, the point cloud data as the detailed information about the structure targeted for the investigation request.

The information presentation means 115 presents these pieces of information by transmitting a map indicating the location of the structure, image data selected by the first selection means 113, and point cloud data selected by the second selection means 114 to a predetermined output destination.

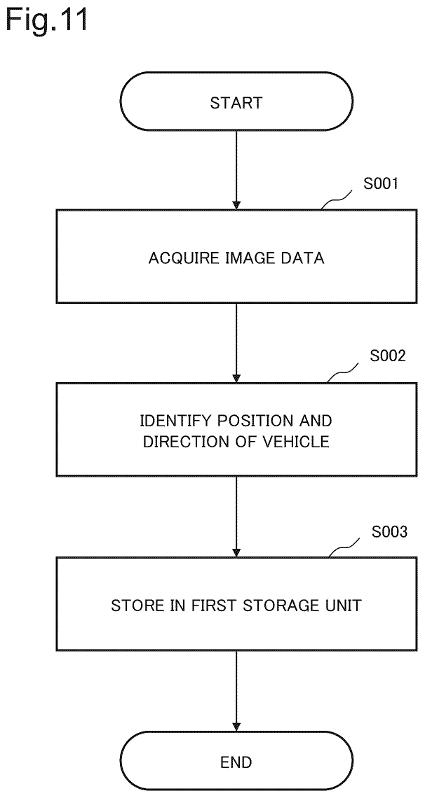

Next, the operation of the present example embodiment will be described in detail with reference to the drawings. FIG. 11 is a flowchart illustrating an operation (processing of image data) of the structure investigation assistance system according to the first example embodiment of the present invention. Referring to FIG. 11, the structure investigation assistance system 100 acquires image data from the vehicle Va on which the camera 210 is mounted (step S001).

Next, the structure investigation assistance system 100 identifies the imaging position and imaging direction information about the acquired image data (step S002). The imaging position of the image data can be identified, for example, from the GPS position information designated to the image data. The imaging direction of the image data can be identified from a change in the GPS position information or the image data itself.

Next, the structure investigation assistance system 100 stores the image data in the first storage means 111 together with the identified imaging position and imaging direction information about the image data (step S003).

By repeating the above processing, the image data of each point on the road is accumulated in the first storage means 111.

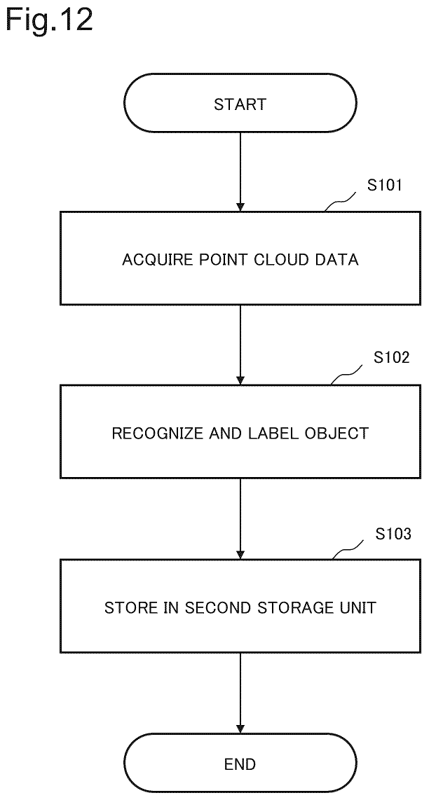

FIG. 12 is a flowchart illustrating an operation (processing of point cloud data) of the structure investigation assistance system according to the first example embodiment of the present invention. Referring to FIG. 12, the structure investigation assistance system 100 acquires point cloud data obtained by scanning a structure around a road from the vehicle Vb on which the 3D laser scanner 220 and the like are mounted (step S101).

Next, the structure investigation assistance system 100 performs cleaning process on the acquired point cloud data to recognize and label the object represented by the point cloud data (step S102).

Next, the structure investigation assistance system 100 stores the point cloud data subjected to the object recognition and the labeling in the second storage means 112 (step S103).

By repeating the above processing, the point cloud data of the structures around the road is accumulated in the second storage means 112.

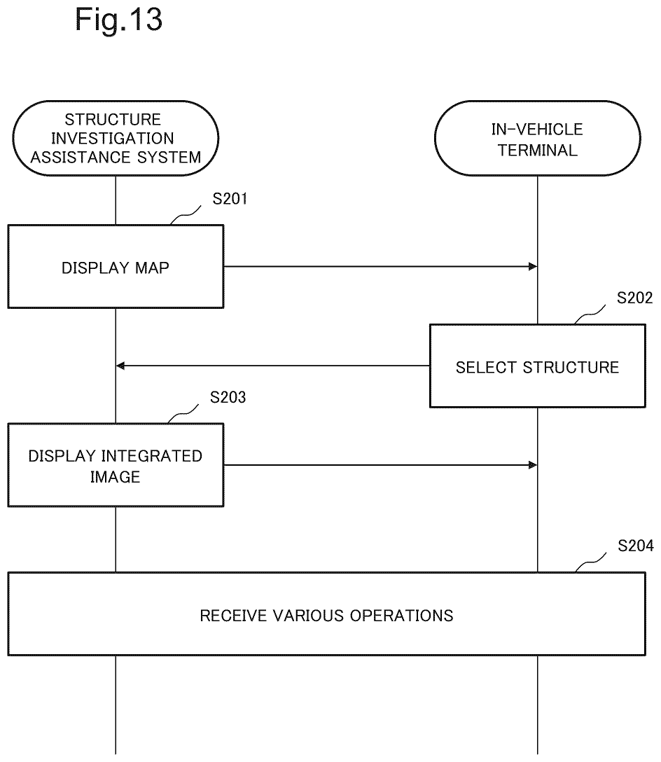

Next, an operation of the structure investigation assistance system 100 when receiving a request for an investigation of the structure from the user will be described. FIG. 13 is a sequence diagram illustrating an information presentation operation of the structure investigation assistance system according to the first example embodiment of the present invention. Referring to FIG. 13, the structure investigation assistance system 100 displays a map of an area where structures that can be invested exist on an in-vehicle terminal or the like of the vehicle Vc (step S201).

When the user of the in-vehicle terminal of the vehicle Vc with reference to the map selects a structure, a request for an investigation of the selected structure is transmitted to the structure investigation assistance system 100 (step S202).

The structure investigation assistance system 100 that has received a request for an investigation of the structure selects the image data and the point cloud data from the first and second storage means 111 and 112, creates an integrated image by integrating the image data and the point cloud data, and displays the integrated image on the display device of the in-vehicle terminal (step S203).

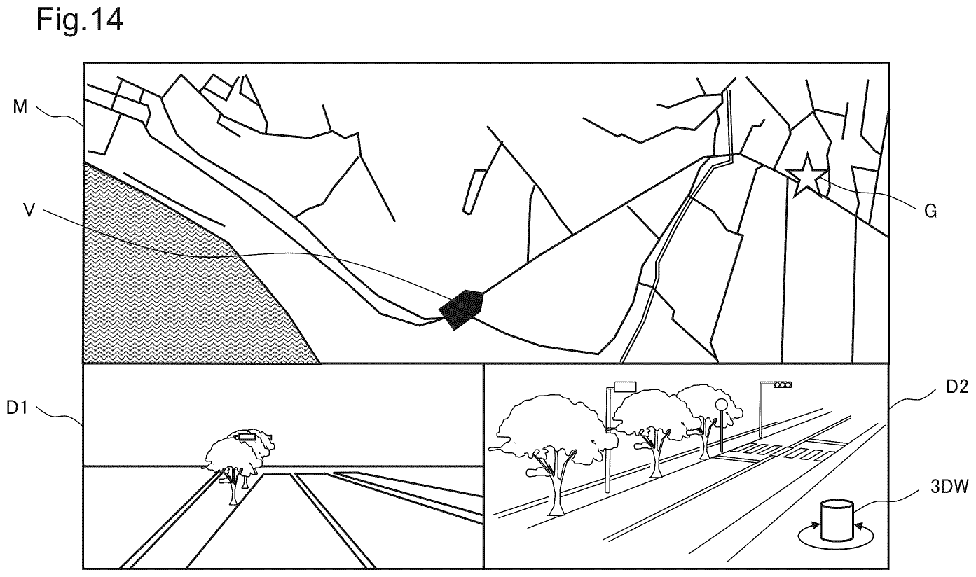

FIG. 14 is a diagram illustrating an example of an integrated screen presented on the in-vehicle terminal of the structure investigation assistance system 100 according to the first example embodiment of the present invention. In the example of FIG. 14, a marker V indicating the position of the vehicle Vc and a map indicating the position of the structure with a marker G are displayed in the upper part of the screen.

An area DI on the lower left in FIG. 14 is a display area of image data, and image data in the course of that the investigation implementer is heading for the position G of the structure from the current location V is displayed. An area D2 on the lower right in FIG. 14 is a display area of the point cloud data, and a 3D wheel 3DW is displayed at the lower right of the area D2.

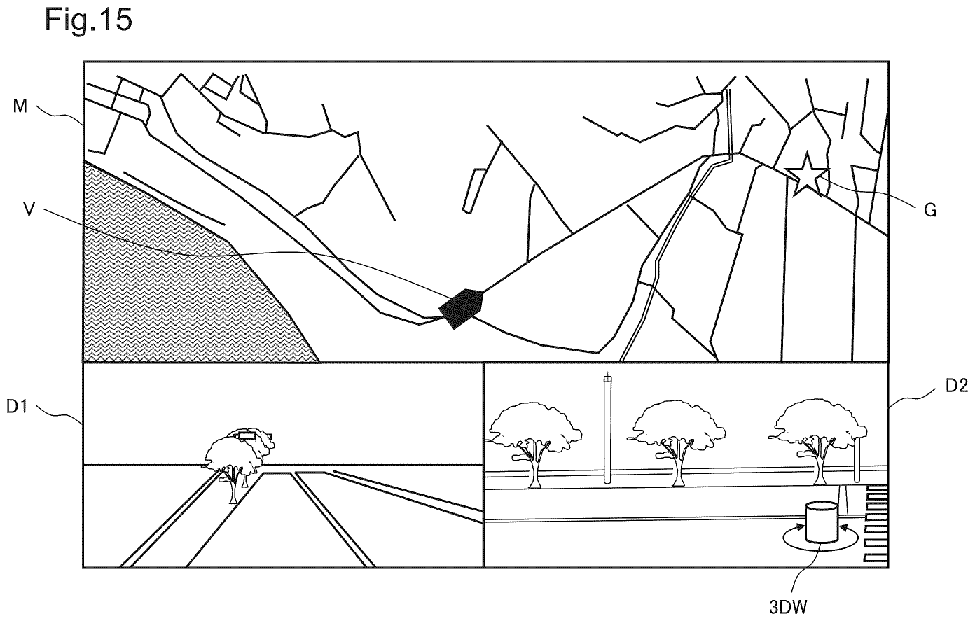

Thereafter, the structure investigation assistance system 100 receives various operations from the in-vehicle terminal, and changes the integrated screen according to the content thereof (step S204). For example, when the user of the in-vehicle terminal rotates the 3D wheel 3DW in the left direction, the area D2 of the integrated screen changes as illustrated in FIG. 15. Referring to FIG. 15, the point cloud data of the area D2 is changed to a state in which the three street trees are seen from the side in response to the left rotation operation. The user of the in-vehicle terminal refers to such a display to grasp the local situation and determine whether it is necessary to prune street trees. Of course, as illustrated in FIG. 10, the structure investigation assistance system 100 may present the amount of protrusion of a street tree and the degree of hiding of a sign in response to a request from a user.

As described above, according to the present example embodiment, it is possible to facilitate investigation work of workers and the like heading for a structure around the roads for investigation. The reason is that the route to the structure to be investigated is grasped from the image data represented in the area D1 of the integrated screen, and the difference from the current state is easily grasped from the point cloud data represented in the area D2 of the integrated screen.

### Second Example Embodiment

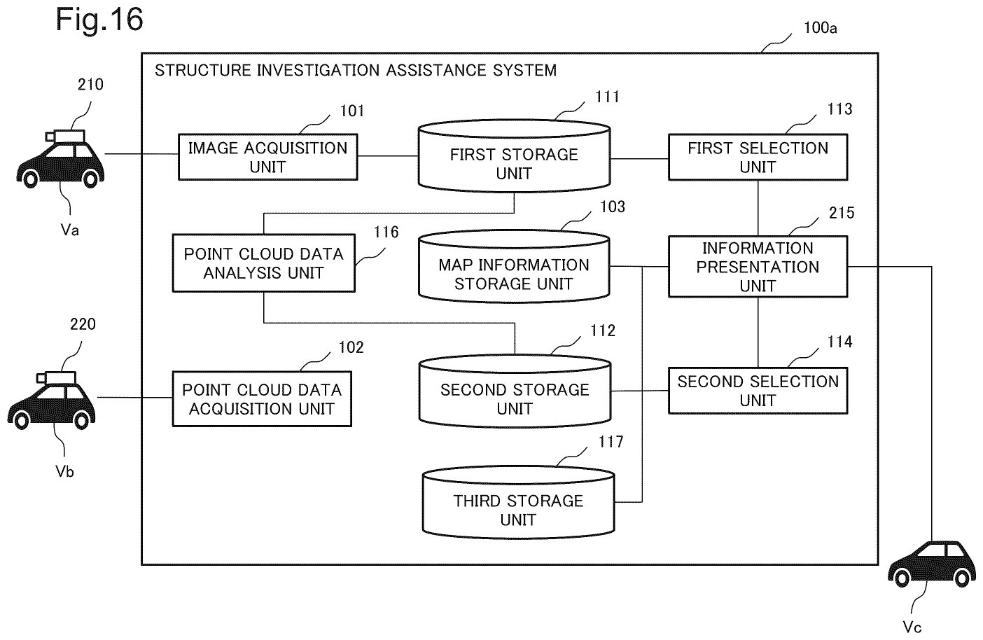

Next, the second example embodiment in which a function of presenting design drawing data of a structure is added to the structure investigation assistance system 100 will be described in detail with reference to the drawings. FIG. 16 is a diagram illustrating a configuration of a structure investigation assistance system 100a according to the second example embodiment of the present invention. A difference from the structure investigation assistance system 100 of the first example embodiment illustrated in FIG. 3 is that a third storage means 117 is added, and an information presentation means 215 is configured to be able to display an integrated screen using design drawing data. Since the other configurations are similar to those of the first example embodiment, differences thereof will be mainly described below.

The third storage means 117 stores design drawing data of a structure to be investigated. The design drawing data can include data provided from an administrator or the like of the structure.

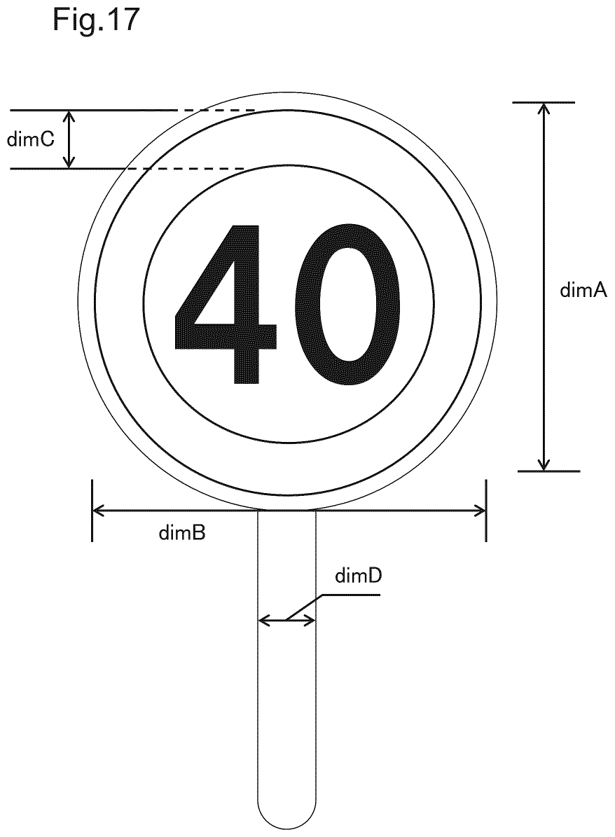

FIG. 17 is a diagram illustrating an example of design drawing data held in the third storage means 117. In the example of FIG. 17, design drawing data in which the dimensions dimA to dimD of the sign are written is stored.

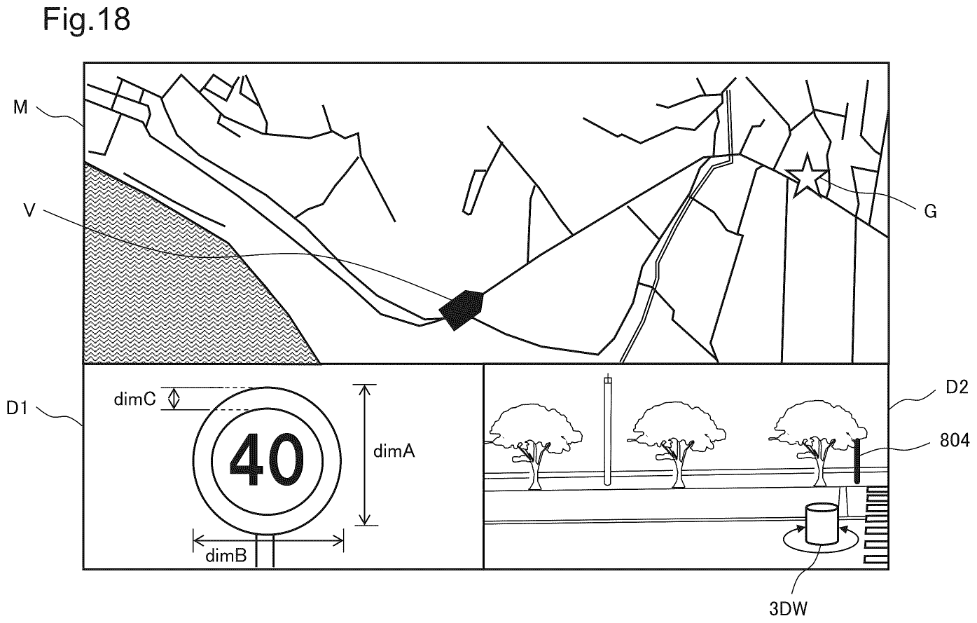

When receiving a provision request for the design drawing data of the structure from the user of the in-vehicle terminal, the information presentation means 215 presents the design drawing data on the integrated screen. FIG. 18 is a diagram illustrating an example of an integrated screen displayed on the in-vehicle terminal by the structure investigation assistance system 100a. In the example of FIG. 18, the design drawing data is superimposed and displayed in the display area D1 of the image data. A worker or the like heading for an investigation of a structure around a road can grasp a damage state of a sign and a consistency state with the point cloud data with reference to the design drawing data.

Although the example embodiments of the present invention have been described above, the present invention is not limited to the above-described example embodiments, and further modifications, substitutions, and adjustments can be made without departing from the basic technical idea of the present invention. For example, the network configuration, the configuration of respective elements, and the expression form of data illustrated in the drawings are examples for assisting the understanding of the present invention, and are not limited to the configurations illustrated in the drawings.

For example, in the first and second example embodiments described above, it is described that the display destination of the integrated screen is the display device of the in-vehicle terminal of the vehicle Vc, but the display destination of the integrated screen is not limited thereto. For example, the integrated screen may be displayed on a mobile terminal of a worker or a terminal of an administrator of a structure such as a local government.

In the above example embodiment, the image data is acquired from the vehicle Va, but the acquisition source of the image data is not limited to the vehicle. For example, the image data may be acquired from a camera installed in a moving body such as a drone, or the image data may be acquired from a fixed camera. Of course, it is also possible to adopt a configuration in which the first selection means appropriately selects and presents appropriate data from the image data.

Similarly, in the above-described example embodiment, it is described that the point cloud data is acquired from the vehicle Vb, but the acquisition source of the image data is not limited to the vehicle. For example, the point cloud data may be acquired from a 3D laser scanner installed in a moving body such as a drone, or the point cloud data may be acquired from a fixed camera. Of course, it is also possible to adopt a configuration in which the second selection means appropriately selects and presents appropriate data from among these point cloud data.

### Hardware Configuration

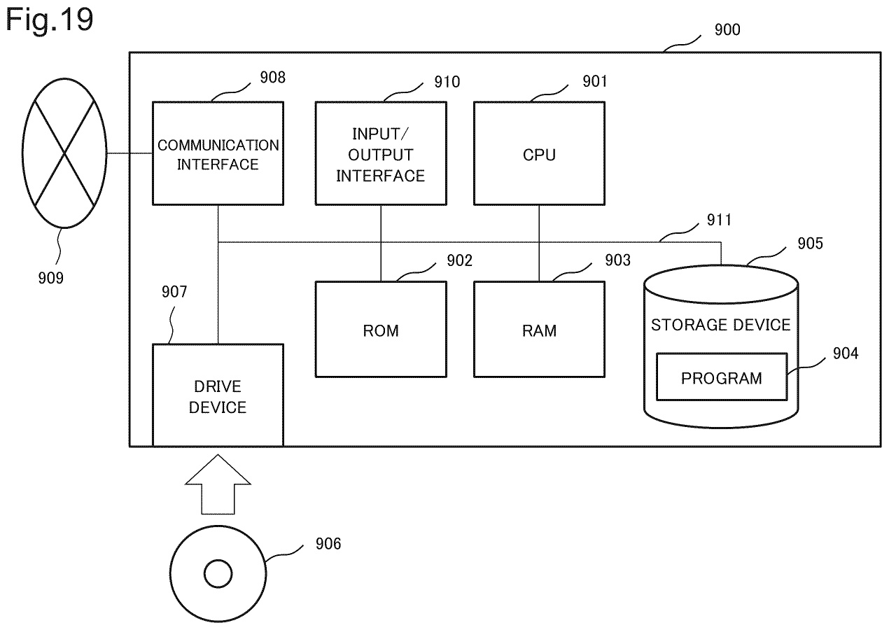

In each example embodiment of the present disclosure, each component of each device indicates a block of a functional unit. Part or all of each component of each device is achieved by, for example, any combination of an information processing device 900 and a program as illustrated in FIG. 19. FIG. 19 is a block diagram illustrating an example of a hardware configuration of the information processing device 900 that achieves each component of each device. The information processing device 900 includes the following configuration as an example.
Central processing unit (CPU) 901
Read only memory (ROM) 902
Random access memory (RAM) 903
Program 904 loaded to RAM 903
Storage device 905 storing program 904
Drive device 907 reading and reading recording medium 906
Communication interface 908 connected with a communication network 909
Input/output interface 910 for inputting/outputting data
Bus 911 connecting respective components

Each component of each device in respective example embodiments is achieved by the CPU 901 acquiring and executing the program 904 for achieving these functions. That is, the CPU 901 of FIG. 19 may execute the data acquisition program and the signal schedule creation program to perform update processing of each calculation parameter held in the RAM903, the storage device 905, and the like. The program 904 for achieving the function of each component of each device is stored in the storage device 905 or the ROM 902 in advance, for example, and is read by the CPU 901 as necessary. The program 904 may be supplied to the CPU 901 via the communication network 909, or may be stored in advance in the recording medium 906, and the drive device 907 may read the program and supply the program to the CPU 901.

The program 904 can display the processing result including the intermediate state for each stage via the display device as necessary, or can communicate with the outside via the communication interface. The program 904 can be recorded on a computer-readable (non-transitory) recording medium.

There are various modifications of the implementation method of each device. For example, each device may be achieved by any combination of the information processing device 900 and the program separate for each component. A plurality of components included in each device may be achieved by any combination of one information processing device 900 and a program. That is, each unit (processing means and function) of the signal control system described in the first to fourth example embodiments can be implemented by a computer program that causes a processor mounted in the device to execute each processing described above using hardware thereof.

Part or all of each component of each device is achieved by another general-purpose or dedicated circuit, processor, or the like, or a combination thereof. These may be configured by a single chip or may be configured by a plurality of chips connected via a bus.

Part or all of each component of each device may be achieved by a combination of the above-described circuit or the like and the program.

In a case where part or all of each component of each device is achieved by a plurality of information processing devices, circuits, and the like, the plurality of information processing devices, circuits, and the like may be disposed in a centralized manner or in a distributed manner. For example, the information processing device, the circuit, and the like may be achieved as a form in which each of the information processing device, the circuit, and the like is connected via a communication network, such as a client and server system, a cloud computing system, and the like.

Each of the above-described example embodiments is a preferred example embodiment of the present disclosure, and the scope of the present disclosure is not limited only to each of the above-described example embodiments. That is, it is possible for those of ordinary skill in the art to make modifications and substitutions of the above-described example embodiments without departing from the gist of the present disclosure, and to construct a mode in which various modifications are made.

Some or all of the above example embodiments may be described as the following Supplementary Notes, but are not limited to the following.

### Supplementary Note 1

A structure investigation assistance system including
a first storage means for storing image data of a road captured continuously by a camera,
a second storage means for storing detailed information about a structure around the road in association with position information about the structure on a map,
a first selection means for selecting, from the first storage means, image data targeted for an investigation request in a case where a request for an investigation of the structure is received,
a second selection means for selecting, from the second storage means, detailed information about the structure targeted for the investigation request, and
an information presentation means for presenting a map indicating a location of the structure, the image data selected by the first selection means, and the detailed information about the structure, wherein
the detailed information about the structure is configured using point cloud data obtained by 3D scanning the structure.

### Supplementary Note 2

The first selection means of the structure investigation assistance system described above may be configured to select, as image data for targeted for the investigation request, from the first storage means, image data in a course of that an investigation implementer is heading for the structure from the current location.

### Supplementary Note 3

The structure investigation assistance system described above may further include
an estimation means for estimating an overall image of a structure hidden by overlapping of subjects in the image data by using the point cloud data, wherein
the information presentation means may be configured to present detailed information about the structure estimated by the estimation means.

### Supplementary Note 4

The structure investigation assistance system described above, wherein the information presentation means may be configured to present point cloud data of the structure when viewed in a direction same as a direction of image data selected by the first selection means.

### Supplementary Note 5

The structure investigation assistance system described above, may further include
a third storage means for storing design drawing data of the structure, wherein
the information presentation means may be configured to present the design drawing data of the structure in response to a request from a user.

### Supplementary Note 6

A structure investigation assistance method including
selecting, from a first storage means, image data in a course of that an investigation implementer is heading for the structure from a current location, the first storage means receiving a request for an investigation of a structure and storing image data of a road continuously captured by a camera mounted on a vehicle,
selecting, from a second storage means, detailed information about a structure targeted for the investigation request, the second storage means storing detailed information in association with position information about the structure on a map, the detailed information being configured point cloud data obtained by 3D scanning the structure, and
presenting a map indicating a location of the structure, the selected image data, and the detailed information about the structure.

### Supplementary Note 7

A computer-readable recording medium storing a program for causing a computer to execute the steps of
selecting, from a first storage means, image data in a course of that an investigation implementer is heading for the structure from a current location, the first storage means receiving a request for an investigation of a structure and storing image data of a road continuously captured by a camera mounted on a vehicle,
selecting, from a second storage means, detailed information about a structure targeted for the investigation request, the second storage means storing detailed information in association with position information about the structure on a map, the detailed information being configured point cloud data obtained by 3D scanning the structure, and
presenting a map indicating a location of the structure, the selected image data, and the detailed information about the structure.

The forms of Supplementary Note 6 to Supplementary Note 7 can be expanded to the forms of Supplementary Note 2 to Supplementary Note 5, as in the Supplementary Note 1.

The disclosure of the above PTL is incorporated herein by reference, and can be used as a basis or part of the present invention as necessary. Within the frame of the entire disclosure (including the claims) of the present invention, it is possible to change and adjust the example embodiments or examples further based on of the basic technical idea thereof. Various combinations or selections (including partial deletions) of various disclosure elements (respective elements of each claim, respective elements of each example embodiment or example, respective elements of each drawing, and the like are included) can be made within the frame of the disclosure of the present invention. That is, it goes without saying that the present invention includes various modifications and corrections that can be made by those of ordinary skill in the art in accordance with the entire disclosure including the claims and the technical idea. Specifically, for numerical ranges set forth herein, any numerical value or sub-range included within the range should be construed as being specifically described, even when not stated otherwise. Furthermore, it is also deemed that in the matters disclosed in the document cited above, using part or all of the matters disclosed in the document in combination with the matters described in the present specification as part of the disclosure of the present invention according to the gist of the present invention as necessary is included in the matters disclosed in the present application.

### REFERENCE SIGNS LIST

10, 100, 100a structure investigation assistance system
11, 111 first storage means
12, 112 second storage means
13, 113 first selection means
14, 114 second selection means
15, 115, 215 information presentation means
101 image acquisition means
102 point cloud data acquisition means
103 map information storage means
116 point cloud data analysis means
117 third storage means
801 traffic signal
802 street light
803, 803-1 to 803-3 street tree
804 sign
210 camera
220 3D Laser Scanner
Va, Vb, Vc vehicle
V, G marker
D1, D2 area
3DW 3D wheel
900 information processing device
901 central processing unit (CPU)
902 read only memory (ROM)
903 random access memory (RAM)
904 program
905 storage device
906 recording medium
907 drive device
908 communication interface
909 communication network
910 input/output interface
911 bus

What is claimed is:

1. A structure investigation assistance system comprising:
a memory; and
at least one processor coupled to the memory
the at least one processor performing operations to:
store image data of a road captured continuously by a camera;
store detailed information about a structure around the road in association with position information about the structure on a map, the detailed information on the structure being configured using point cloud data obtained by 3D scanning the structure,
select, from the stored image data, image data targeted for an investigation request in a case where a request for an investigation of the structure is received;
select, from the stored detailed information, detailed information about the structure targeted for the investigation request; and
present a map indicating a location of the structure, the image data selected, and the detailed information about the structure.

2. The structure investigation assistance system according to claim 1, wherein the at least one processor further performs operation to:
select, as the image data targeted for the investigation request, from the stored image data, image data in a course of that an investigation implementer is heading for the structure from a current location.

3. The structure investigation assistance system according claim 1, wherein the at least one processor further performs operation to:
estimate an overall image of a structure hidden by overlapping of subjects in the image data by using the point cloud data, and
present detailed information about the structure estimated.

4. The structure investigation assistance system according to any claim 1, wherein the at least one processor further performs operation to:
present point cloud data of the structure when viewed in a direction same as a direction of image data selected.

5. The structure investigation assistance system according to claim 1, wherein the at least one processor further performs operation to:
store design drawing data of the structure, and
present the design drawing data of the structure in response to a request from a user.

6. A structure investigation assistance method comprising:
selecting, from a first storage unit, image data targeted for an investigation request, the first storage unit receiving a request for an investigation of a structure and storing image data of a road continuously captured by a camera;
selecting, from a second storage unit, detailed information about a structure targeted for the investigation request, the second storage unit storing detailed information in association with position information about the structure on a map, the detailed information being configured point cloud data obtained by 3D scanning the structure; and
presenting a map indicating a location of the structure, the selected image data, and the detailed information about the structure.

7. A non-transitory computer-readable recording medium storing a program for causing a computer to execute the steps of:
selecting, from a first storage unit, image data targeted for an investigation request, the first storage unit receiving a request for an investigation of a structure and storing image data of a road continuously captured by a camera;
selecting, from a second storage unit, detailed information about a structure targeted for the investigation request, the second storage unit storing detailed information in association with position information about the structure on a map, the detailed information being configured point cloud data obtained by 3D scanning the structure; and
presenting a map indicating a location of the structure, the selected image data, and the detailed information about the structure.
